(19) United States
(12) Patent Application Publication
(10) Pub. No.: US 2026/0309207 A1
(43) Pub. Date: Oct. 8, 2026

(54) TOOTHED BELT HAVING FABRIC LAYER WITH REDUCED POROSITY

(71) Applicant: GATES CORPORATION, Denver, CO (US)

(72) Inventor: Thomas S. MOSS, III, Englewood, CO (US)

(73) Assignee: GATES CORPORATION, Denver, CO (US)

(21) Appl. No.: 19/481,838

(22) PCT Filed: May 3, 2024
(86) PCT No.: PCT/US2024/027771

§ 371 Date: Nov. 5, 2025

Related U.S. Application Data
(60) Provisional application No. 63/500,492, filed on May 5, 2023.

(51) Int. Cl. F16G 1/28; B32B 5/02; B32B 25/02; B32B 25/10; B32B 25/16

(52) U.S. Cl. CPC F16G 1/28; B32B 5/024; B32B 25/02; B32B 25/10; B32B 25/16; B32B 2262/0261; B32B 2264/101; B32B 2413/00

(57) ABSTRACT

Toothed belts, and methods of making toothed belts, having a reinforcing fabric layer incorporated therein, the fabric layer having a low porosity. The fabric layer has a porosity of no greater than 25%. With the low porosity fabric layer, the elongation of the belt decreases and the abrasion resistance increases, both providing increased operable life of the belt.

### CROSS REFERENCE TO RELATED APPLICATIONS

This application claims priority to International Application No. PCT/US2024/027771, filed May 3, 2024 and U.S. Provisional Patent Application No. 63/500,492, filed May 5, 2023, and entitled TOOTHED BELT HAVING FABRIC LAYER WITH REDUCED POROSITY, the entirety of which is hereby incorporated by reference.

### TECHNICAL FIELD

The present application relates generally to flexible belts for use with a sprocket, more particularly, to toothed flexible belts having a fabric reinforcement layer.

### BACKGROUND

Power transmission belts generally work in concert with a toothed gear or sprocket that engages the toothed belt and moves the belt upon rotation of the gear or sprocket. An insufficiently rigid belt/tooth may stretch under load, which may lead to the tooth of the belt unmeshing from the teeth of the gear or sprocket, referred to as tooth jump. Accordingly, a need exists for belts having limited elongation (extension, or stretch) when under.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

The present disclosure is directed to toothed belts, such as for use with e-bikes and other personal mobility systems such as standard bicycles, wheelchairs, scooters including electric scooters, motorcycles, and other systems that utilize a belt for transmitting power to impart motion to the system. The toothed belts can also be used in systems that conventionally use a chain and a sprocket(s) or gears to transmit power, such as in drive systems, including the mobility systems described above. The toothed belts can also be used in industrial drive systems and automotive applications.

The present disclosure provides toothed belts, and methods of making toothed belts, having a fabric layer incorporated therein, the fabric layer having a low porosity. With the low porosity fabric layer, the elongation of the belt decreases, the abrasion resistance and thus the operable life of the belt increases.

In one particular embodiment, this disclosure describes a reinforced belt having a flexible body having a back surface and a front surface, with a plurality of alternating teeth and lands defining the front surface, and an infused fabric layer proximate the front surface having a porosity of no more than 20%, the fabric layer comprising a plurality of threads and an infusion composition.

In another particular embodiment, this disclosure describes a method of making a reinforced belt. The method includes infusing a base fabric with an infusion composition to provide a reinforcing fabric having a porosity no greater than 20%, and molding a toothed belt with the reinforcing fabric embedded in a belt composition.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a fragmented perspective view of a portion of a toothed belt.

FIG. 2 is an enlarged side view of an infused fabric showing porosity.

FIG. 3 is an enlarged side view of an infused multi-layer fabric showing porosity.

FIG. 4A and FIG. 4B are graphical representations of belt thickness as a function of applied load.

FIG. 5 is a stepwise flow chart showing steps for forming a belt.

### DETAILED DESCRIPTION

As indicated above, the present description provides toothed belts having a reinforcing fabric layer with a low porosity incorporated proximate the toothed surface, and methods of making the belt. In some embodiments, the fabric layer is exposed at the toothed surface.

In the following description, reference is made to the accompanying drawing that forms a part hereof and in which is shown by way of illustration at least one specific implementation. The following description provides additional specific implementations. These embodiments are disclosed in sufficient detail to enable those skilled in the art to practice the invention. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

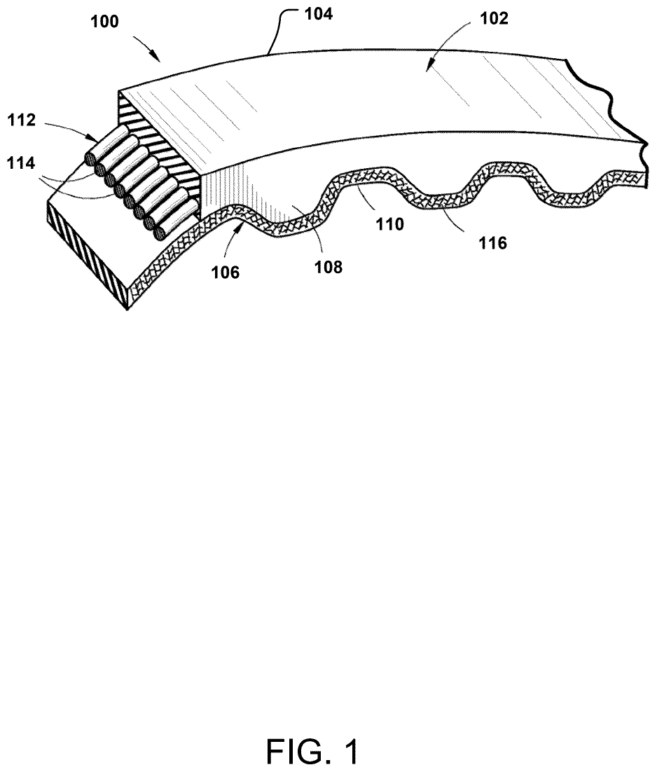

Turning to the figures, a portion of a belt 100 is illustrated in FIG. 1. The belt 100 includes an elastomeric main body 102 having a back side 104 and a front side 106, the front side 106 also referred to as a sheave contact portion. This particular front side 106 has a plurality of alternating transverse teeth 108 and land portions 110 which are designed to mesh with a transverse-grooved pulley, gear, or sprocket when the belt 100 is in use. Although not seen in FIG. 1, the belt 100 is typically an endless belt, having the form of a loop with no beginning and no end.

An internal reinforcing layer 112 is positioned within the body 102 for providing support and strength to the belt 100. In the illustrated form, the reinforcing layer 112 is a plurality of load carrying tensile cords 114 aligned and extending longitudinally along the length of the body 102. These cords 114 may contact each other or may be spaced apart. It should be understood that, in general, any type of reinforcing layer 112 known to the art may be utilized. The belt body 102 may include reinforcement material in addition to the load carrying cords 114, material such as chopped fiber segments, though other reinforcement material such as elongated segments, fibers, or nanotubes, can also be used. The reinforcement material, whether chopped, segments, or elongate fibers as load carrying cords 114, may be, e.g., aramid, polyester (PET), cotton, nylon, glass, carbon fiber cords, hybrid cords, metal, ceramic, and other plastic. The reinforcement material may be made from either organic or synthetic material, or a mixture of organic and synthetic materials. The reinforcing material may be treated, e.g., with an elastomeric material, such as a polybutadiene elastomer. The material may include a size coating (e.g., epoxy, urethane) prior to application of the treatment material.

In addition to the internal reinforcing layer 112 positioned within the body 102, the belt 100 includes a reinforcing fabric 116 close to or forming the front side 106 of the belt 100. The reinforcing fabric 116 intimately fits along the alternating teeth 108 and lands 110 to form a face cover or tooth cover for the sheave contact portion. An amount of material forming the body 102 may be present over the reinforcing fabric 116, however for the most part, the fabric 116 is present on or at the front side 106, following the topography of the teeth 108 and the lands 110 and forming the outer surfaces of the teeth 108 and the lands 110.

This fabric 116 may be of any desired configuration such as a conventional weave consisting of warp and weft threads at any desired angle or may consist of warp threads held together by space pick cords, or of a knitted or braided configuration, or a nonwoven fabric, and the like. More than one ply or layer of fabric may be used, including combinations of different fabric types. If desired, the fabric 116 may be cut on a bias so that the strands form an angle (other than parallel or perpendicular) with the direction of travel of the belt 100.

Conventional fabrics may be used as the fabric 116, materials such as cotton, polyester, polyamide, acrylic, rayon, viscose, polyaramid, polypropylene, polyethylene, polyketone, hemp, jute, fiberglass, and various other natural and synthetic fibers including blends or combinations thereof. In some embodiments, the fabric 116 may include ceramic fibers, carbon fibers, or metal fibers. In one embodiment, the fabric 116 is an expansible wear-resistant fabric in which at least one of the warp or weft threads is made of nylon. In another embodiment, the fabric 116 is made from a nylon 66 stretch fabric and has an elastomer-free (e.g., polyurethane/urea-free) surface; the elastomer-free surface may be a coating or a polymeric film laminated to the fabric.

The fabric 116 has a porosity of less than or no more than 20%, in some embodiments less than or no more than 15%, in other embodiments less than or no more than 10%, and yet in other embodiments less than or no more than 5%. To achieve this porosity, a base fabric is infused, impregnated, infiltrated, or coated with a composition that reduces the porosity of the fabric 116 to less than or no more than 20% by volume, in some embodiments to less than or no more than 15%, in other embodiments to less than or no more than 10%, and yet in other embodiments to less than or no more than 5%. The infusion composition at least partially covers the threads of the fabric and fills in at least some of the space between the fabric threads.

By having the fabric 116 at less than 20% porosity, in some embodiments even less, improvements in belt wear resistance, and thus improved belt life, are seen. Belt wear and thus life are improved by increased abrasion resistance afforded by the low porosity. By having less porosity in the fabric 116, less surface area of the fabric threads is exposed, decreasing the potential for physical abrasion and damage of the threads due to engagement with a sprocket, gear, or wheel, and decreasing the potential for environmental degradation of the threads due to exposure to fluids (e.g., oils, lubricants, etc.) and airborne particulate contaminants.

Belt life is also improved due to decreased belt elongation afforded by the low porosity, which results in less physical strain on the teeth 108 during engagement of the teeth with a sprocket, gear, or wheel. It has been found that at least a portion of belt elongation is due to the thickness of the fabric decreasing when under tension, due to the porosity collapsing and allowing internal shifting within the fabric. By having less porosity in the fabric 116, the fabric 116 is more stable under tension. Increased stability provides a more stable and less flexible tooth 108. Additionally, belt life is also improved due to decreased elongation due to decreased compression of the fabric 116, and hence the belt 100, under load. Decreased compression occurs due to the low amount of porosity in the fabric 116 available to be compressed.

Decreased elongation, in general, inhibits “tooth jumping,” which happens when a toothed belt stretches under an applied load and slips or “jumps” in the gear. During jumping, the tooth does not engage or mesh correctly with the drive mechanism. Generally, belts having an elongation or stretch less than 0.25% per 1,500N of incremental load provide the desired operating properties. In some embodiments, the belts have an elongation less than 0.22% per 1,500N of incremental load.

With decreased elongation and decreased compression, the ability to optimize the fit of the belt to the gear or sprocket, to take advantage of the interaction of the belt surface with the gear or sprocket surface, is increased. Optimized fit is when the calculated performance of the system is within criteria that is supported by experimental and simulation data, e.g., stress analysis from finite element modeling. The specific criteria are the amount of tension required to wrap (fit) the belt to the wheel (also referred to as pitch equalizing tension (PET)), the maximum load transferred between a single belt tooth and groove of the wheel (referred to as maximum tooth load (MTL)), and lack of any loads that interfere with the efficient transfer of power between the belt and wheel (referred to as negative tooth loads). The criteria can be adjusted for certain optimization targets; for example, noise, vibration and/or harness (NVH) adjustments may focus on a smaller range, or subset, of the durability range. Adjustments can be made to also improve NVH which uses a subset of the criteria, in some embodiments the NVH criteria being predetermined.

The criteria not only determine optimum fit but can determine how removed from optimum the system fit can be and still be acceptable. Specifically, pitch equalizing tension is kept between a minimum and maximum, which can be determined by experimental results and supported by finite element analysis (FEA), for example, by contour plots that identify optimal regions and non-optimal regions based on stresses and wear indices. The ideal maximum tooth load is based on a theoretical minimum load (with all the load distributed equally between the meshed teeth); the ratio of the maximum tooth load to the theoretical minimum load is considered with the knowledge that durability of the belt decreases with increase in maximum tooth load. In summary, non-optimal fit is any of the pitch equalizing tension being less than the minimum criteria, the pitch equalizing tension being above the maximum criteria, or the existence of negative tooth loads. Since tooth load considered independently of bending and other fatigue factors has an exponential impact on tooth load, optimization is considered when the maximum load is less than what a “matching” fit would yield. Decreased belt elongation facilitates obtaining a matching fit.

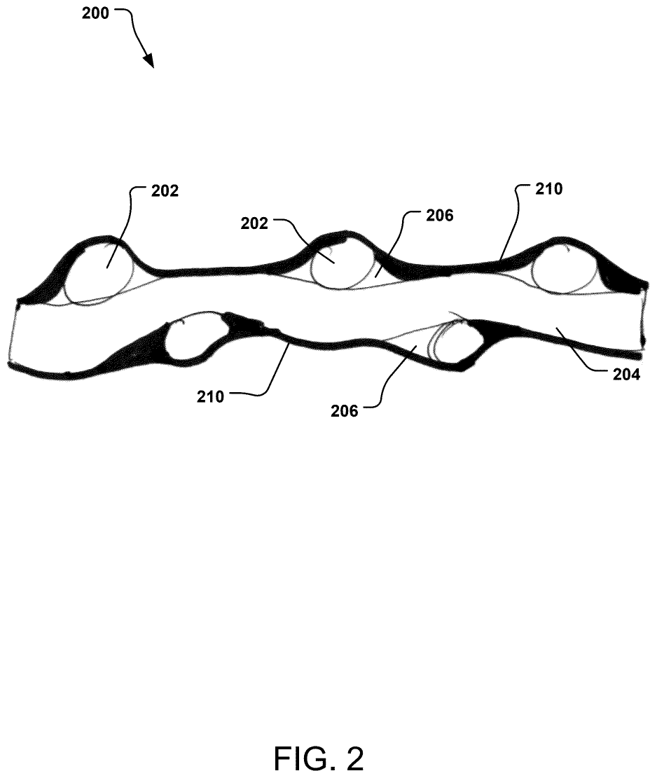

FIG. 2 shows an example of a fabric 200 infused with a composition to achieve a porosity of no more than 20% by volume, in some embodiments no more than 15%, in other embodiments no more than 10%, and yet in other embodiments no more than 5%, the porosity being calculated based on the volume occupied by the fabric, the infusion composition, and the pores. The fabric 200 in FIG. 2 is a single layer woven fabric, composed of interwoven warp threads 202 and weft threads 204, formed from, e.g., nylon. The fabric 200 has a three-dimensional property due to the interweaving of the threads 202, 204 and the non-planar nature of each of the individual threads 202, 204. A composition 210 is present on the threads 202, 204, coating and enveloping at least a portion of the surface of the threads 202, 204. Generally, not 100% of the volume between the threads 202, 204 is coated with the composition 210, but rather, an amount of open pores 206 remains between coated threads 202, 204; that is, a volume of air remains within the fabric 200. This volume of air, or porosity, is no more than 20% of the volume of the fabric 200. In some embodiments, the pore 206 is a volume proximate the intersection of the threads 202, 204. The pores 206 may have different shapes and/or sizes within the fabric 200. Additionally, the coating of the composition 210 may be thicker or thinner.

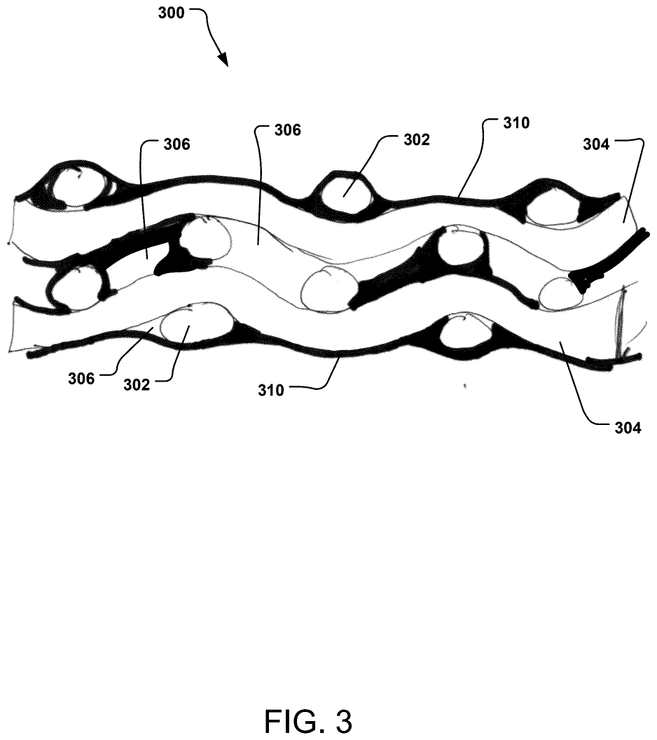

FIG. 3 shows another example of a fabric 300 having a porosity of no more than 20% by volume, in some embodiments no more than 15%, in other embodiments no more than 10%, and yet in other embodiments no more than 5% porosity. The fabric 300 is a multiple layer woven fabric, composed of layers of interwoven warp threads 302 and weft threads 304. The fabric 300 has a three-dimensional property due to the interweaving of the threads 302, 304 and the non-planar nature of each of the individual threads 302, 304 within each layer. A composition 310 is present on the threads 302, 304, coating and enveloping at least a portion of the surface of the threads 302, 304. Generally, not 100% of the volume between the threads 302, 304, is coated with the composition 310, but rather, pores 306 remain between coated threads 302, 304. These pores 306 may have different shapes and/or sizes within the fabric 300.

In this fabric 300, the pores 306 are internal pores, not homogeneously distributed through the fabric 300 but present predominantly in the interior of the fabric 300, between the two layers of the warp and weft threads 302, 304, with the outer surfaces of the outer threads 302, 304 essentially completely coated. In other embodiments, more or less of the outer surfaces of the threads 302, 304 may be coated. Additionally, the coating of the composition 310 may be thicker or thinner.

It is noted that although both shown fabrics 200, 300 are woven, having warp and weft threads, other fabrics may be used, such as knits, braids, nonwovens, felts, etc. Similar to the fabrics 200, 300, voids or porosity will remain proximate regions where threads or fibers intersect, particularly in the interior of the fabric.

Whether the porosity in the fabric 200, 300 is homogeneously distributed through the fabric or not, the infused, infiltrated, coated or impregnated fabric 200, 300 has a compression value that correlates to the amount of porosity in the fabric 200, 300. The compression of the fabric 200, 300 is determined by the change in the thickness of the fabric 200, 300, when incorporated into a belt, when under load (the load being applied with the belt mounted on two wheel, gears, or sprockets).

The compression of the fabric is due not only to the collapse of porosity in the fabric, but also due to elongation of the belt due to elongation of the reinforcing layer (e.g., reinforcing layer 112, such as cords 114, of FIG. 1) in the belt, which is a function of Young's Modulus. By knowing the fabric compression due to elongation due to elongation of the reinforcing layer, the fabric compression due to porosity can be calculated.

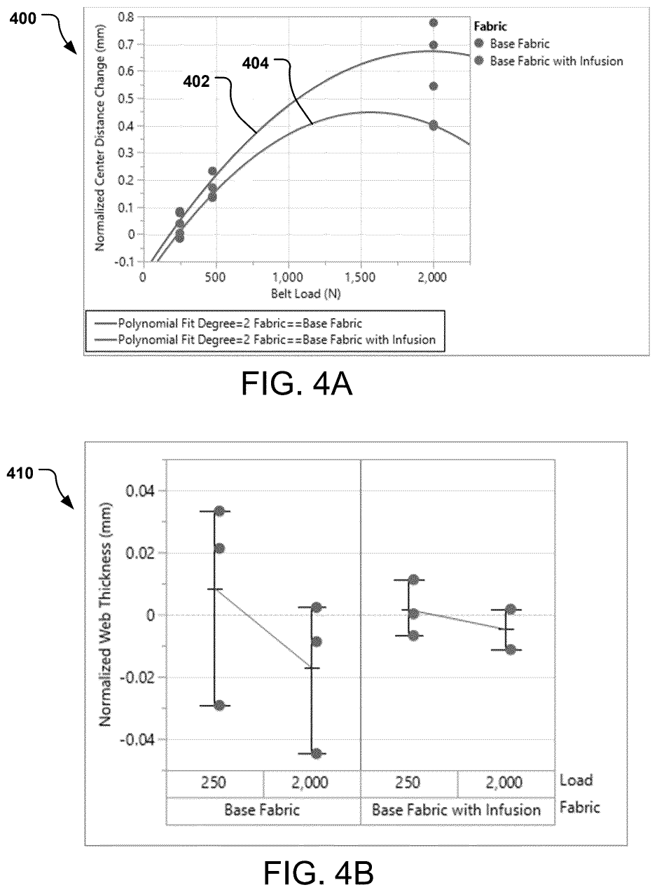

FIGS. 4A and 4B show an example of decreased fabric compression due to infusion of the fabric with a composition to decrease porosity.

FIG. 4A shows a graph 400 illustrating the difference in compression in a fabric versus an infused fabric. In the graph 400, line 402 shows a belt made with a standard base fabric under various loads, and line 404 shows a belt made with the same fabric infused and under various loads. As seen in FIG. 4A, the belt with the infused fabric withstands compression better than the belt with the original fabric, with the difference in compression increasing as the load increases; the slope of the line 404 is markedly less than the slop of the line 402.

FIG. 4B shows a graph 410 with the base fabric and the infused fabric, both incorporated into a belt and test at 250N and 2,000N loads. As seen in FIG. 4B, the belt with the infused fabric has significantly less thickness decrease, and hence compression, than the belt with the base fabric.

As example, an original fabric with a thickness of about 400 micrometers compresses about 25 micrometers whereas the same fabric, albeit infused, compresses about 6 micrometers at the same applied load.

The amount of compression, measured along the thickness of the fabric 200, 300, is no more than 5% of the uncompressed thickness of the fabric 200, 300, in other embodiments no more than 4% and even no more than 3% compression. The particular correlation of the compression in relation to the applied load will depend on the physical properties of the fabric and the infusion composition, and may be, e.g., linear, exponential, quadratic, or even undefined.

The infusion composition most commonly includes a polymeric material as the base ingredient, however other materials such as metals or ceramics may be the base ingredient. Examples of suitable polymeric materials include latex, polyurethane, vinyl, ethylene, acetates, and rubber, although other materials could be used. The infusion composition can include various additives, in addition to the base materials, such as activators, fillers, curing agents, reinforcing materials, antidegradants (e.g., antioxidants, UV stabilizers), plasticizers, antistatic agents, colorants, processing aids, homogenizers, coagents, catalysts, and the like. Various additional functional components can be added to this composition, as well as any other composition, to modify, e.g., the coefficient of friction, resistance to environmental exposure, and the toughness of the materials.

The infusion composition may be, e.g., from about 10-50% solids, in some implementations about 20-30%, e.g., 25%. The infusion composition may have, e.g., a viscosity of about 25 cps. A lower solids percentage and/or lower viscosity allows more thorough and consistent infusion of the composition into the fabric, particularly in multiple layer fabrics.

In one particular embodiment, the fabric infusion composition includes hydrogenated nitrile butadiene rubber (HNBR), silica (e.g., used as filler and for structural improvements), and appropriate curative(s) and reaction accelerator(s). Various additional functional components can be added to this composition, as well as any other composition, to modify the coefficient of friction and the toughness of the materials.

The ingredients forming the infusion composition can be blended by conventional blending methods. In some implementations, the mixing is generally carried out using an industrial mixer, such as a Banbury mixer, to mix together all ingredients; however, other mixing techniques and methods can be used. In some implementations, the individual ingredients are added into the mixer in a specific sequence to ensure sufficient incorporation and dispersion of the ingredients. In some implementations, certain raw ingredients can be mixed together prior to being added in sequence into the mix.

The resulting infusion composition can be applied to the fabric by conventional coating methods, including dipping, spraying, and knife coating. In some implementations, the amount of infusion composition on and in the fabric is 5-25 vol-%, in some implementations about 8-20 vol-%. The infusion, infiltration, coating or impregnation process may be done at atmospheric pressure, at elevated pressure to press the composition into the fabric, or with the fabric under vacuum to suck the composition into the fabric.

The infusion composition described herein is formulated for compatibility with the fabric (e.g., nylon, and any coating) as well as with the belt composition, including rubber, polyurethane (PU) including milled polyurethane (MPU) and thermoplastic polyurethane (TPU), and ethylene elastomers (EE). Bonding (e.g., including cross-linking) of the infusion composition with the belt composition may be via hydrogen bonding, electrostatic/ionic bonding, dipole to dipole interactions, Van der Waals interactions, and/or by covalent bonding. The curing process may be initiated or facilitated by peroxide or sulfur radicals, or photo-initiated radicals (from, e.g., UV, visible, or IR photoinitiators).

Returning to FIG. 1, material of the body 102 of the belt 100 is generally not limited, and any suitable material can be used; numerous examples of materials/ingredients suitable for the body 102 of the belt 100 are discussed below. Typically, the base material used for the belt body 102 and the teeth 108 is a polymer material, such as a natural or synthetic rubber material or polyurethane, although other suitable materials may also be used. Various filler materials may also be included within the material of the belt body and/or teeth to add further structural stability to the belt, while in other implementations, the belt may be free or substantially free of fillers. The belt 100 shown in FIG. 1 may also include additional features not shown in FIG. 1. For example, a cover layer (e.g., coating) may be provided on the exterior surface of the teeth 108, or a textile or polymeric backing layer may be provided on the back surface 104 of the body 102 opposite the front surface 106 having the teeth 108 and lands 110.

The belt body 102 is a moldable, flexible material and can be, e.g., rubber, polyurethane, polyethylene, and others. Suitable materials include, for example, polyurethane elastomers (including polyurethane/urea elastomers and so-called millable gums) (PU), polychloroprene rubber (CR), acrylonitrile butadiene rubber (NBR), hydrogenated NBR (HNBR), styrene-butadiene rubber (SBR), alkylated chlorosulfonated polyethylene (ACSM), polyepichlorohydrin, polybutadiene rubber (BR), natural rubber (NR), and ethylene alpha olefin elastomers such as ethylene propylene copolymers (EPM), ethylene propylene diene terpolymers (EPDM), ethylene octene copolymers (EOM), ethylene butene copolymers (EBM), ethylene octene terpolymers (EODM); and ethylene butene terpolymers (EBDM); ethylene vinylacetate elastomers (EVM); ethylene methylacrylate (EAM); and silicone rubber, or a combination of any two or more of the foregoing.

The raw materials forming the belt body are often in the form of a solid powder, pellet, bale or block, although in some implementations may be a liquid or semi-liquid.

The belt composition can include a peroxide or other accelerator to facilitate curing of the composition. Various types of organic peroxides can be used; organic peroxides undergo decomposition at a certain temperature and produce radicals that initiate a cross-linking reaction in the compound. One particular example of an organic peroxide for use with polyethylene is a,a-bis (t-butylperoxy) diisopropyl-benzene.

Polymer compositions cured with organic peroxides exhibit higher thermal resistance due to the formation of C—C cross links between the polymer chain. In contrast, sulfur cured polymers form C—S—C or C—(S)x-C bonds. Formation of mono sulfidic (i.e., C—S) bonds or poly sulfidic bonds (i.e., S—S) bonds leads to inferior thermal resistance of the polymer. Some sulfur-cross-links may result in poor oxidation resistance. The C—C bond energy (346 k J/mol) is higher than both C—S (272 k J/mol) and S—S (226 k J/mol) bond energy; this reflects in the higher temperature resistance of peroxide cured vulcanizate.

The belt composition can include various additives such as activators, fillers, curing agents, reinforcing materials, antidegradants (e.g., antioxidants, UV stabilizers), plasticizers, antistatic agents, colorants, processing aids, homogenizers, coagents, catalysts, and the like. Generally, the total wt-% of such additives is less than 75 wt-% of the raw ingredients of the total composition, in some implementations less than 65 wt-% or less than 50 wt-%.

Examples of activators include stearic acid and zinc oxide.

Any suitable curing agent(s) or material can be used, with the agent facilitating or assisting during curing. Example curing agent(s) suitable include sulfur and peroxides.

Silica may be added to provide greater tensile strength, higher modulus, reduced compression set, and increased abrasion resistance to the belt composition. Silica is typically a solid, e.g., powder, and may be treated or untreated. Treated silica material has low moisture absorption and significantly low volatile formation during mixing and processing.

Carbon black and/or graphite can be used as a filler in rubber compounds. Examples of other fillers include metal oxides such as aluminum oxide, magnesium oxide, and zinc oxide, clay, montorillonite clay, pulp, and mica.

Polymers, in general, are subject to degradation when exposed to different types of environmental factors, factors including oxygen, heat/temperature, UV light, weathering, catalytic degradation due to heavy metal ions, dynamic fatigue, etc. The failures observed in rubber compounds due to environmental degradation include loss of elasticity and tensile strength, formation of crazed surface, and appearance of cracks. The presence of unsaturation in a polymer can increase the tendency of failure due to heat ageing, due to the allylic C—H bond in an unsaturated chemical structure. The bond energy of allylic C—H is weakest among different type (primary, secondary, tertiary) of C—H bonds. This factor promotes the formation of free radicals and peroxy radicals in the presence of oxygen and heat and causes chain scission and cross-linking; it is noted that excessive cross-linking can create embrittlement. Once the polymer main chain is degraded and/or broken, the compound starts to lose its physical and mechanical strength and the physical properties begin to degrade. Antioxidants acts as a radical trap; they scavenge radicals to stop polymer chain scission, stabilize properties, and enhance the service life of the resulting product.

An antioxidant that can be used in belt compounds is a polymerized quinoline derivative, 1,2-dihydro-2,2,4-tri-methylquinoline. Another antioxidant is a condensate of alkylated imidazole and diarylamine or ketone, and another is a condensate of mercaptobenzimidazole and diphenyleamine/acetone; these are strong non staining antioxidants for natural and synthetic rubber and offer extremely good temperature and flex protection at elevated temperatures.

Plasticizers can be added to the belt compounds for various reasons, such as increasing softness or flexibility, lowering the glass transition temperature, reducing crystallization, increasing dispersion, or lowering the cost of the compound. Common are mineral oils and esters such as phthalates, sebacates, and adipates.

Di-alkyl ester and di octyl adipate (DOA) are highly efficient plasticizers that can be used to impart excellent low temperature flexibility and resistance to impact to the belt compound. In addition to their high efficiency and contribution to the low temperature properties, they are chemically stable and resistant to discoloration on extended exposure to temperature and ultraviolet light. The combination of low viscosity and efficiency provide excellent dry blending and processing characteristics.

Microcrystalline wax can be added as a physical antiozonant. Polymer chains containing double bonds are vulnerable to ozonolysis reaction and chain scission when in the presence of ozone. Microcrystalline wax provides a shielding layer or barrier over the compound and protects it from degradation because of chain scission.

Modified resorcinol, which is a resorcinol formaldehyde homopolymer resin modified with a selected group, can be used as a precondensed dry bonding agent; chemically, it is a resorcinol formaldehyde homopolymer resin modified with a selected group. Modified resorcinol can facilitate the bonding of the belt composition to the elastomer adhesive composition.

Metallic acrylates such as zinc dimethacrylate can be used to boost the physical and mechanical properties of the belt and acts as a coagent. In the presence of organic peroxide, metallic coagents form ionic bonds and improves tear strength, modulus, and flex resistance of the compound.

Modified polybutadiene (e.g., with maleic anhydride) can be used as a bonding promoter in peroxide cured vulcanizates. Chemically, it is a low molecular weight, low vinyl butadiene functionalized with maleic anhydride. The anhydride functionality can react with epoxy, amine, and hydroxyl groups, enabling the creation of unique adhesives, sealants, encapsulants, and coatings. It also improves compatibility of a non-polar elastomer such as EPDM and increases the adhesion of peroxide cured elastomers to polyester, aramid or metal substrates.

A substituted phenolic derivative can be used as a scorch inhibitor for peroxide cured systems. It initially forms an adduct to trap the radical from the peroxide and affects the processing and flow time to the compound.

The polymers and any other ingredients can be blended by conventional rubber blending methods. In some implementations, the mixing is generally carried out using an industrial mixer, such as a Banbury mixer, to mix together all raw ingredients; however, other mixing techniques and methods can be used. For example, roll mills and internal mixers can be used. In some implementations, the individual raw ingredients are added into the mixer in a specific sequence to ensure sufficient incorporation and dispersion of the raw ingredients. In some implementations, certain raw ingredients can be mixed together prior to being added in sequence into the mix.

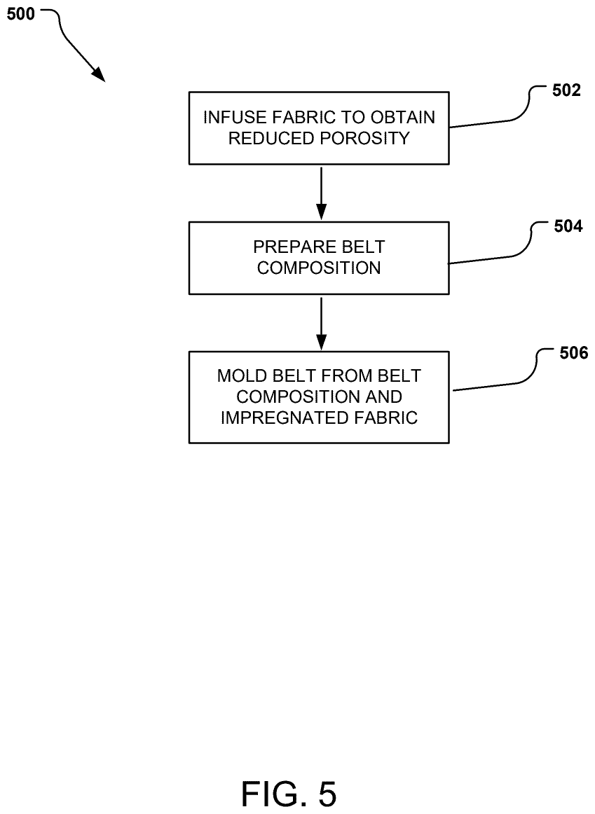

Any of the materials, described above, can be used to form a belt, e.g., for power transmission uses, having a fabric reinforcing layer with a low porosity, the belt having, e.g., increased life compared to a similar belt with a fabric layer having higher porosity. FIG. 5 describes a generalized method for preparing a belt having cords coated with an infusion composition.

FIG. 5 provides an example method 500 for forming a toothed belt as described herein. In a first step 502, a fabric material is infused with a composition, such as a polymeric composition. The composition is cured to obtain a fabric with a reduced porosity, having no more than 20% porosity, in some embodiments even less porosity. In a second step 504, ingredients are combined to prepare a belt composition. In a step 506, a belt is molded by placing the belt composition and the infused fabric material in a mold, the molding forming a plurality of teeth and lands in one side of the belt. The molded material is cured, as appropriate, and the belt is removed from the mold.

It is noted that the steps may be done in an order other than provided above in the method 400. For example, the belt composition may be prepared prior to the fabric material being infused.

From the foregoing, it will be appreciated that specific embodiments of the invention have been described herein for purposes of illustration, but that various modifications may be made without deviating from the scope of the invention. Features or elements from one embodiment may be used or exchanged with features or elements of another embodiment. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately” or “about.” At the very least, and not as an attempt to limit the application of the doctrine of equivalents to the claims, each numerical parameter recited in the specification or claims which is modified by the term “approximately” or “about” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

1. A reinforced belt comprising:
a flexible body having a back surface and a front surface, with a plurality of alternating teeth and lands defining the front surface, and
a reinforcing fabric layer proximate the front surface, the reinforcing fabric having a porosity of no more than 20%.

2. The reinforced belt of claim 1, further comprising an internal reinforcing layer within the body between the back surface and the reinforcing fabric layer.

3. The reinforced belt of claim 2, wherein the internal reinforcing layer comprises a plurality of cords extending longitudinally along a length of the belt.

4. The reinforced belt of claim 1, wherein the reinforcing fabric has a porosity of no more than 15%.

5. The reinforced belt of claim 1, wherein the reinforcing fabric has a porosity of no more than 10%.

6. The reinforced belt of claim 1, wherein the reinforcing fabric has a porosity of no more than 5%.

7. The reinforced belt of claim 1, wherein the reinforcing fabric comprises nylon threads.

8. The reinforced belt of claim 7, wherein the reinforcing fabric further comprises hydrogenated nitrile butadiene rubber (HNBR) and silica.

9. A reinforced belt comprising:
a flexible body having a back surface and a front surface, with a plurality of alternating teeth and lands defining the front surface, and
an infused fabric layer proximate the front surface having a porosity of no more than 20%, the fabric layer comprising a plurality of threads and an infusion composition.

10. The reinforced belt of claim 9, wherein the fabric layer is a woven material.

11. The reinforced belt of claim 10, wherein the woven material has multiple woven layers.

12. The reinforced belt of claim 11, wherein the porosity is predominantly internal to the fabric layer.

13. The reinforced belt of claim 9, wherein the porosity is distributed homogeneously throughout the fabric layer.

14. The reinforced belt of claim 9, wherein the threads comprise nylon and the infusion composition comprises hydrogenated nitrile butadiene rubber (HNBR) and silica.

15. A method of making a reinforced belt, the method comprising:
infusing a base fabric with an infusion composition to provide a reinforcing fabric having a porosity no greater than 20%;
molding a toothed belt with the reinforcing fabric embedded in a belt composition.

16. A reinforcing fabric layer for a flexible belt, comprising a plurality of threads comprising nylon coated with an infusion composition comprising rubber and a particulate filler, the fabric layer having a porosity of no more than 10%.

17. The fabric layer of claim 16, wherein the rubber comprises hydrogenated nitrile butadiene rubber (HNBR) and the particulate filler comprises silica.
